(19) United States
(12) Patent Application Publication
(10) Pub. No.: US 2014/0344283 A1
(43) Pub. Date: Nov. 20, 2014

(54) METHOD OF SERVER-BASED APPLICATION HOSTING AND STREAMING OF VIDEO OUTPUT OF THE APPLICATION

(71) Applicant: Evology, LLC, Sarasota, FL (US)

(72) Inventor: Jason Frederick Nicholls, Pretoria (ZA)

(73) Assignee: EVOLOGY, LLC, Sarasota, FL (US)

(21) Appl. No.: 14/280,438

(22) Filed: May 16, 2014

Related U.S. Application Data
(60) Provisional application No. 61/824,633, filed on May 17, 2013.

(51) Int. Cl. H04L 29/06

(52) U.S. Cl. CPC H04L 65/60
USPC 707/741; 709/203; 707/822

(57) ABSTRACT

A server-based application hosting and streaming of video output across a network to a client terminal. A method receives, via the network, an initiation request from a client terminal to stream an application from an application server to the client terminal. Retrieving from an application database a common application data image of the application, and retrieving from a profile database incremental application data uniquely associated with the user indicative of a recent application state for the user. The method includes modifying the common application data image in accordance with the incremental application data to create a modified application image which is unique to the user and indicative of the recent application state. The method includes spawning and hosting a user-specific instance of the application based on the modified application image followed by streaming at least video output of the user-specific instance of the application to the client terminal.

### RELATED APPLICATION

This application claims the benefit of priority of U.S. Provisional Application Ser. No. 61/824,633, entitled “Method of Server-Based Application Hosting and Streaming of Video Output of the Application,” filed May 17, 2013, the content of which is hereby incorporated by reference in its entirety.

### TECHNICAL FIELD

This disclosure relates to a method of, and system for, server-based application hosting and streaming of video output of the application across a telecommunications network to a client terminal.

### BACKGROUND OF DISCLOSURE

The Applicant is aware of existing computer-implemented methods and systems which facilitate server-based hosting and execution of software applications which provide a video output and streaming of the video output to a remote client terminal. These methods and systems find particular application in online gaming, in which case the software application is a computer game.

As available communication bandwidth continues to expand, more computer games and other applications are being developed which are intended to be (at least partially) server-hosted to serve a multitude of client terminals which are usually geographically remote from the server. Each user may have an account profile associated with the application containing user-specific settings and data. In the case of computer games, an account profile may include game preferences, game progress information, e.g. saved game data, and miscellaneous (possibly even private) information uniquely associated with a specific user and not with any other users.

Applications which are developed specifically for such server-based hosting preferably have size-efficient account profiles of each user. This is especially important where a large number of users is contemplated, e.g. in a thriving online gaming community. The more users there are, and the larger the account profile of each user, the more server-side data storage space is required. This results in a corresponding increase in costs associated with implementing and maintaining the application server. Ideally, the account profiles should be fairly “thin” or small in size, e.g. a few MB or less.

Further, applications which were not developed specifically to be hosted and streamed from a server can in fact be operated in this fashion, with some adjustments to the hosting or operating environment. The Applicant has filed PCT application no. PCT/IB2013/052172 (the contents of which are incorporated herein by reference) for a method and system for streaming video which may be applied to conventional applications and games (e.g. PC games or console games) which were intended to be executed and displayed locally. The locally executed games, which historically were sold on physical computer-readable media (e.g. optical discs) and which are increasingly becoming available as digital downloads, tend to have very large game images, often in excess of 1 or even 10 GB. The term “game image”, and the corresponding term “application image”, includes a fully executable instance of the game/application, which may be fully installed on local storage of a computing terminal, or partially installed with the installation requiring access to an original source (e.g. the installation disc is required to be in the optical drive).

Thus, the use of server-side storage and bandwidth is exacerbated further when sizable or “thick” conventional applications not intended for server-based execution and streaming are in fact hosted and streamed. Because game images and other game data typically change as the games are played, each account profile may need its own instance of a game or application image. It is not practical simply to delete user data to save space, because a user could lose access to his/her previous game state or inadvertently inherit a game state from another user.

The closest prior disclosures of which the Applicant is aware are US2013/0012310 and WO2012/037165 which both provide systems and methods for server-based computer game (or other application) hosting and streaming of video output to remote client terminals. Each of these disclosures provides a method of application (specifically game) streaming in which general game data and specific account profiles are provided. Generally, the applications are developed for server/client streaming and the different information unique to each user is fairly small in size. However, neither of the discloses describe how to overcome or at least alleviate the above mentioned problems. The Applicant thus desires a method and system for application hosting and streaming which overcomes or at least alleviates the above mentioned problems.

### SUMMARY OF DISCLOSURE

According to one aspect of the disclosure, there is provided a method of server-based application hosting and streaming of video output of the application across a telecommunications network to a client terminal, the method including:
receiving, via the telecommunications network, an initiation request from a client terminal to stream an application from an application server to the client terminal, the request including at least an indication of a user;
retrieving from an application database a common application data image of the application;
retrieving from a profile database incremental application data uniquely associated with the user, the incremental application data being indicative of a recent application state for the user;
modifying the common application data image in accordance with the incremental application data, thereby to create a modified application image which is unique to the user and indicative of the recent application state;
spawning and hosting a user-specific instance of the application based on the modified application image; and
streaming, via the telecommunications network, at least video output of the user-specific instance of the application to the client terminal.

It will be appreciated that the common application data image may be relatively large, in the region of GB, while the incremental application data associated with each user may be relatively small, in the region of MB. Further, the common application data image may be applicable to every potential user of the application, thus necessitating storage of only a single instance of the common application data image, regardless of the number of users. Each user may have incremental application data associated with him/her.

As the user-specific instance of the application is hosted and executed, the application state may be further modified.

The method may include:
receiving, via the telecommunications network, a user input from the client terminal; and
passing the user input to the application.

The method may further include modifying the application state in accordance with the user input.

The method may further include:
analyzing the modified application state to determine incremental differences relative to the common application data image; and
updating, in the profile database, the incremental application data associated with the user in accordance with the determined incremental differences.

The method may then include deleting the user-specific instance of the application after it has been used or when the user is finished with it. Thus, while the application is being actively hosted and streamed to the client terminal of the user, storage space will be required to store the user-specific instance of the application. However, it is envisaged that a small portion of users will be active simultaneously. Thus, the storage space required for inactive users is merely for the smaller incremental application data and not for the larger (and possibly orders or magnitude larger) modified application image.

The application may be intended to be run on a Microsoft™ Windows™ platform. Thus, hosting the user-specific instance of the application may include hosting the application in a Windows environment, whether actual or virtual. Typically, in a Windows environment, data can be stored in two places: in a file system; or in a system registry. Thus, analyzing the modified application state may include:
analyzing the file system; and/or
analyzing the system registry.

Further, the method may include a prior step of analyzing the file system and/or system registry prior to installation of a particular application, thereby to create a control index of a “clean” system, in other words a control index of the system without any application-specific files. Analyzing the file system and/or system registry may include traversing all folders and files of the system. Analyzing the system may further include generating a checksum for each file/folder. The checksum may be created using an MD5 checksum or other hashing algorithm. Thus, the control index may include a copy of each file/registry entry, its size and checksum.

The method may then include installing the application on the system and thereafter analyzing the system again, thereby to create a common application data image. The common application data image may be created by comparing changes in the system after installation of the application to the system prior to installation of the application, e.g. the control index. It may not be necessary to store the entire system with the application installed thereon in the application database, but rather just the changes or “delta” after the installation compared to the control index. This may effectively only include application files or other files modified during installation of the application. This same process may be repeated for the system registry.

The common application data image may then be stored in the application database. In one embodiment, the application database is connected directly to an application server, e.g. via a direct connection and not a telecommunications connection. This is because the common application data image may be relatively large. Conversely, the profile database may be distributed or remote from the application servers, e.g. hosted by a central server or management server, and connected to the application server via a telecommunications connection. This is because incremental application data may be relatively small.

In another embodiment, the application database and profile database may be a common database or stored in a common data warehouse.

It will be appreciated that the control index and the common application data image may only need to be created once for each application, and can then be re-used. Conversely, the incremental application data may be updated periodically, e.g. at an update event. An update event may include a user-initiated save, an autosave, application termination, etc.

The disclosure extends to a system for server-based application hosting and streaming of video output of the application across a telecommunications network to a client terminal, the system including:
a network interface operable to receive an initiation request from a client terminal to stream an application from an application server to the client terminal, the request including at least an indication of a user;
an application module operable to:
   retrieve from an application database a common application data image of the application;
   retrieve from a profile database incremental application data uniquely associated with the user, the incremental application data being indicative of a recent application state for the user;
   modify the common application data image in accordance with the incremental application data, thereby to create a modified application image which is unique to the user and indicative of the recent application state; and
   spawn and host a user-specific instance of the application based on the modified application image; and
a streaming module operable to stream, via the network interface and the telecommunications network, at least video output of the user-specific instance of the application to the client terminal.

The system may include an input module to receive a user input from the client terminal and pass the user input to the application.

The system may include a profile module operable to:
analyze the modified application state to determine incremental differences relative to the common application data image; and
update, in the profile database, the incremental application data associated with the user in accordance with the determined incremental differences.

The system may include a control index module operable to:
analyze a file system/system registry prior to installation of the application thereby to create a control index;
analyze the file system/system registry after installation of the application thereby to create a common application data image.

The disclosure extends further to a non-transitory computer-readable medium having stored thereon a computer program which, when executed by a computer, causes the computer to perform a method as defined above.

### BRIEF DESCRIPTION OF DRAWINGS

The disclosure will now be further described, by way of example, with reference to the accompanying diagrammatic drawings.

In the drawings:

FIG. 1 shows a schematic view of a system for server-based application hosting and streaming of video output of the application, in accordance with the disclosure;

FIG. 2 shows a schematic view of an application server forming part of the system of FIG. 1;

FIG. 3 shows a schematic view of a client terminal forming part of the system of FIG. 1;

FIG. 4 shows a schematic diagram of a database layout forming part of the system of FIG. 1;

FIG. 5 shows a high-level flow diagram of a method of server-based application hosting and streaming of video output of the application, in accordance with the disclosure;

FIG. 6 shows a low-level flow diagram of the method of FIG. 5; and

FIG. 7 shows a diagrammatic representation of a computer within which a set of instructions, for causing the computer to perform any one or more of the methodologies described herein, may be executed.

### DETAILED DESCRIPTION OF EXAMPLE EMBODIMENT

The following description of the disclosure is provided as an enabling teaching of the disclosure. Those skilled in the relevant art will recognize that many changes can be made to the embodiment described, while still attaining the beneficial results of the present disclosure. It will also be apparent that some of the desired benefits of the present disclosure can be attained by selecting some of the features of the present disclosure without utilizing other features.

Accordingly, those skilled in the art will recognize that many modifications and adaptations to the present disclosure are possible and can even be desirable in certain circumstances, and are a part of the present disclosure. Thus, the following description is provided as illustrative of the principles of the present disclosure and not a limitation thereof.

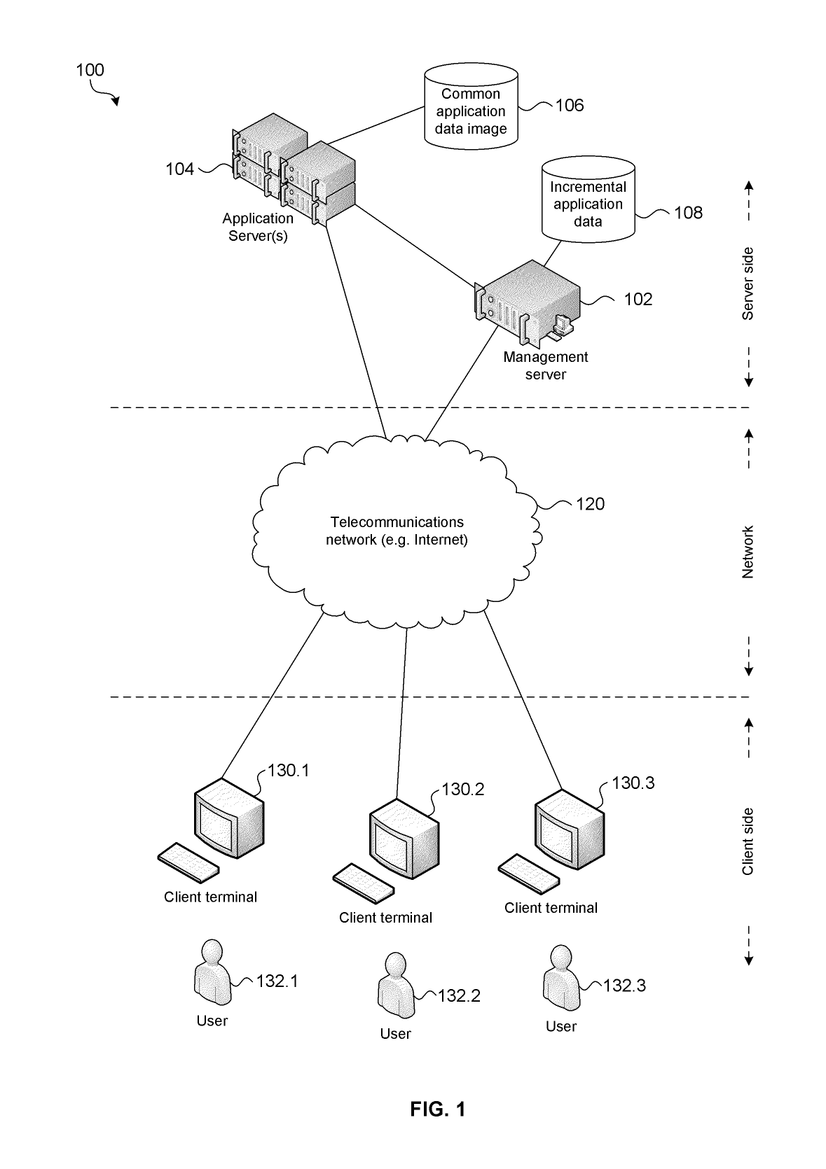

FIG. 1 shows an example system 100 for server-based application hosting and streaming of video output of the application, in accordance with the disclosure. The system 100 in the context of this example provides server-based hosting and streaming of applications to one or more client terminals 130.1-130.3 (collectively referred to by numeral 130). The applications may not have been intended to be operated in this fashion—they may have been intended to have been executed and displayed on a terminal or console, with local processing and display capabilities. Thus, these applications may now be offered to users 132 who previously were unwilling or unable to use them, for example if the client terminals 130 of the users 132 lacked the processing or local storage capabilities.

Further, a wide variety of applications may be streamed, from games to business productivity tools to enterprise level applications. The example lends itself, without limiting itself thereto, to gaming. Thus, the example will be further described to applications in the form of games, but it will be appreciated that there may be many other uses of the system 100. The users 130 may therefore be gamers.

The system includes at least one application server 104—a gaming server in this example. While it is possible to operate the system 100 using a single gaming server, it may be desirable to have a plurality of servers 104 to increase availability and scalability. Thus, the servers 104 may be part of a server farm containing multiple servers. The servers 104 can be configured as a shared resource for the client terminals 130. The servers 104 may include a plurality of physical and/or virtual servers. It is an advantage of the present disclosure that virtualization is possible.

Where there are plural gaming servers 104, it may be desirable to have a management server 102 for system management. The management server 102 may be operable to allocate one of the plural gaming servers 104 based on operational criteria, e.g. availability, relative location, latency, etc. Further, the management server 102 may provide a login interface for the user 132 to login and initiate a gaming session, and thereafter to allocate an appropriate gaming server 104 to the user 132. In other embodiments, the functions of the gaming server 104 and management server 102 could be consolidated into a single server.

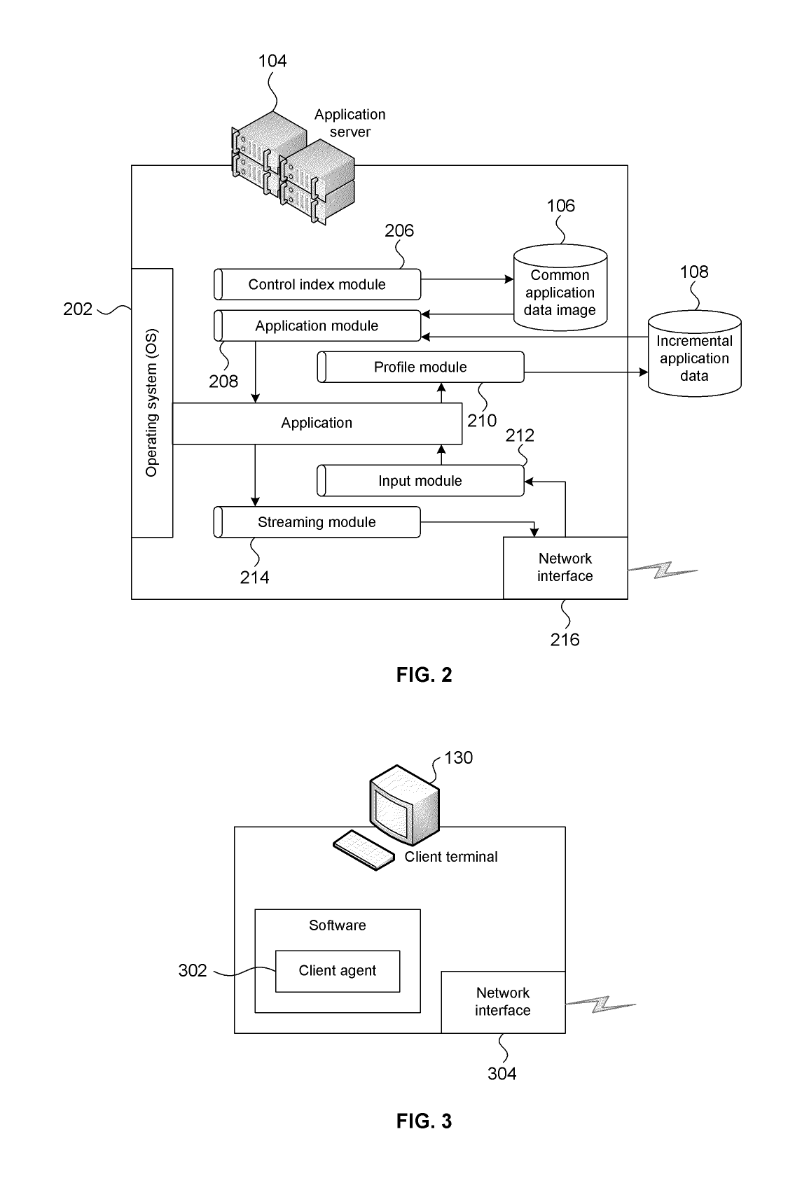

The management server 102 may be accessible via any web-enabled client. The client terminal 130 may use standard Internet protocols for communication between the servers 102, 104. For example, three ports may be used in the connection between the client terminal 130 and servers 102, 104. For streaming purposes, video and audio may be sent using UDP tunneling through TCP/IP or alternatively by HTTP but other protocols are contemplated. Also, the protocol may be RTSP (Real Time Streaming protocol) provided by Live555 (Open Source) used in transporting the video and audio data. The gaming server 104 is described in more detail in FIG. 2.

The servers 102, 104 are connected to the client terminals 130 via a telecommunications network 120. The network 120 may comprise any global or private packet network or telecommunications network including but not limited to the Internet and cellular and telephone networks, and access equipment including but not limited to wireless routers. The network 120 may be the Internet running standard protocols including but not limited to TCP, UDP, and IP. The cellular network can include cellular 3G and 4G networks, satellite networks, cable networks, associated optical fiber networks and protocols, or any combination of these networks and protocols required to transport the process video and audio data.

Each client terminal 130 is used by a corresponding user 132 for gaming purposes. The client terminal 130 may be any device or apparatus (e.g. PC, laptop, mobile device such as a phone or tablet, gaming console, etc.) which is capable of connecting via the Internet 120 and of running client agent software (refer to FIG. 3).

FIG. 2 shows the gaming server 104 in more detail. The gaming server 104 may be a physical server or a virtual server. An advantage of the present disclosure is that it lends itself well to virtualization. In any case, the server 104 includes an operating system (OS) 202. The example is further described with reference to the OS 202 being Microsoft™ Windows™ but the disclosure is not limited thereto. The gaming server 104 includes a plurality of modules (some of which may be optional), namely:
a control index module 206;
an application module 208;
a profile module 210;
an input module 212; and
a streaming module 214.

To this end, the gaming server 104 may include a processor (not illustrated) and the modules 206-214 may be conceptual modules corresponding to functional tasks performed by the processor. To this end, the gaming server 104 may include a computer-readable medium, e.g. main memory, and/or a hard disk drive, which carries a set of instructions to direct the operation of the processor, the set of instructions for example being in the form of a computer program. It is to be understood that the processor may be one or more microprocessors, controllers, digital signal processors (DSPs), or any other suitable computing device, resource, hardware, software, or embedded logic. The functional components are not necessarily consolidated into one device, as in this example, but may be distributed among a number of devices.

The gaming server 104 further includes a network interface 216. Both the application database 106 and the profile database 108 are in communication with the gaming server 104, whether via a direct connection (e.g. a hardware bus) or a networked connection. In this example, the gaming server 104 may be dedicated to a particular application 220 (in the form of a computer game). Thus, the application database 106, storing the common application image data, is preferably hosted by the gaming server 104 for quick access. Games, especially graphics-intensive games, are often relatively large, in the region of GB and can be over 10 GB. It may be impractical to transfer this large data image over the Internet 120 every time a new session is initiated. Conversely, the profile database 108 may be hosted remotely by the management server 102 because the incremental game (application) data may be quite small, e.g. a few MB, which may only take moments to transfer over an Internet connection.

While the modules 206-214 are described in depth below in the practical example, here follows a brief overview. The control index module 206 is operable to generate a control index of the OS 202 prior to game installation (e.g. a “Clean” OS). This may only need to be done once for each game 220, and not every time a new gaming session is initiated. The control index includes a copy of each file/registry entry, its size and checksum. Further, the control index module 206 is operable to analyze the OS 202 after installation of the game 220 to create a common game data image (that which is stored on the application database 106). The common game data image may be created by the control index module 206 comparing changes in the OS 202 after installation of the game 220 to the OS 202 prior to installation of the game 220, i.e. the control index. Only the changes or “delta” caused by installation of the game 220 are stored, and this then constitutes the common game data image, which may be communicated to each gaming server 104 which may potentially host that game 220.

The application module 208 is operable to spawn and host a user-specific instance of the game 220. This is realized by retrieving from the application database 106 the common game data image and also retrieving from the profile database 108 incremental game data (if present) uniquely associated with the user 132 who initiated the session. The application module 208 then modifies the common game data image in accordance with the incremental game data, thereby to create a modified game image which is unique to the user 132 and indicative of a previous game state of the user 132.

The profile module 210 is operable to maintain and update the incremental game data in the profile database 108 in response to changes in the game state. This is done by comparing the present game state to the common game data image and saving any incremental changes to the files/registry entries.

The input module 212 and streaming module 214 are responsible, respectively, for, parsing user input received at the client terminal 130 and communicated to the gaming server 104 to the game 220, and for streaming video and audio from the application 220 via the Internet 120 to the client terminal 130.

FIG. 3 shows the client terminal 130, which includes a network interface 304 (e.g. a wired or wireless modem/radio/router) and a client agent 302. The client agent 302 is operable to display the streamed video and audio generated at the gaming server 104 by the game 220 on local output devices, e.g. a display screen and audio speakers. Further, the client agent 302 is operable to receive a user input from the user 132 via input devices (e.g. mouse, keyboard and/or touchscreen) of the client terminal 130 and to send communications indicative of the received user input to the gaming server 104.

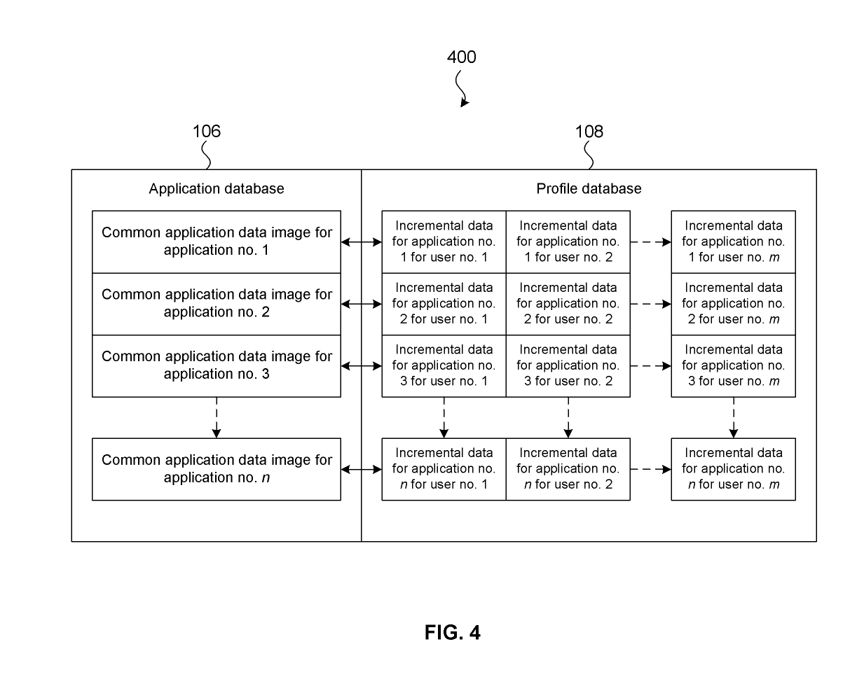

FIG. 4 shows a conceptual view of the data stored on the databases 106, 108.

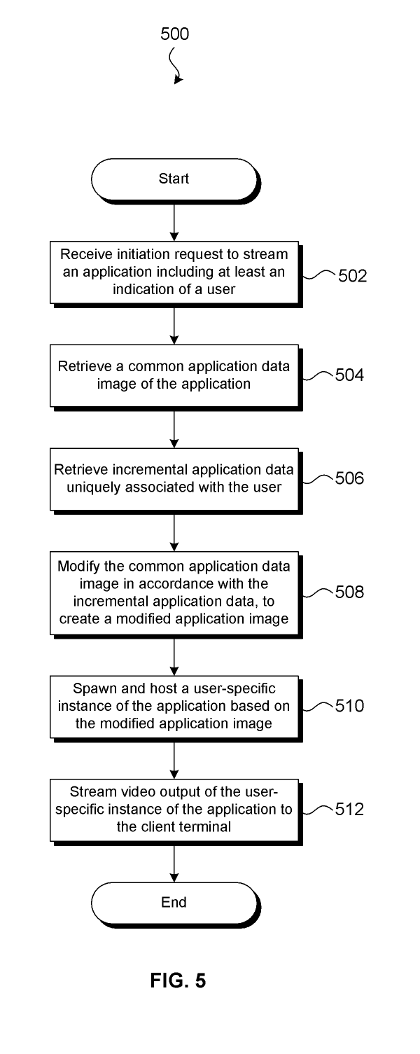

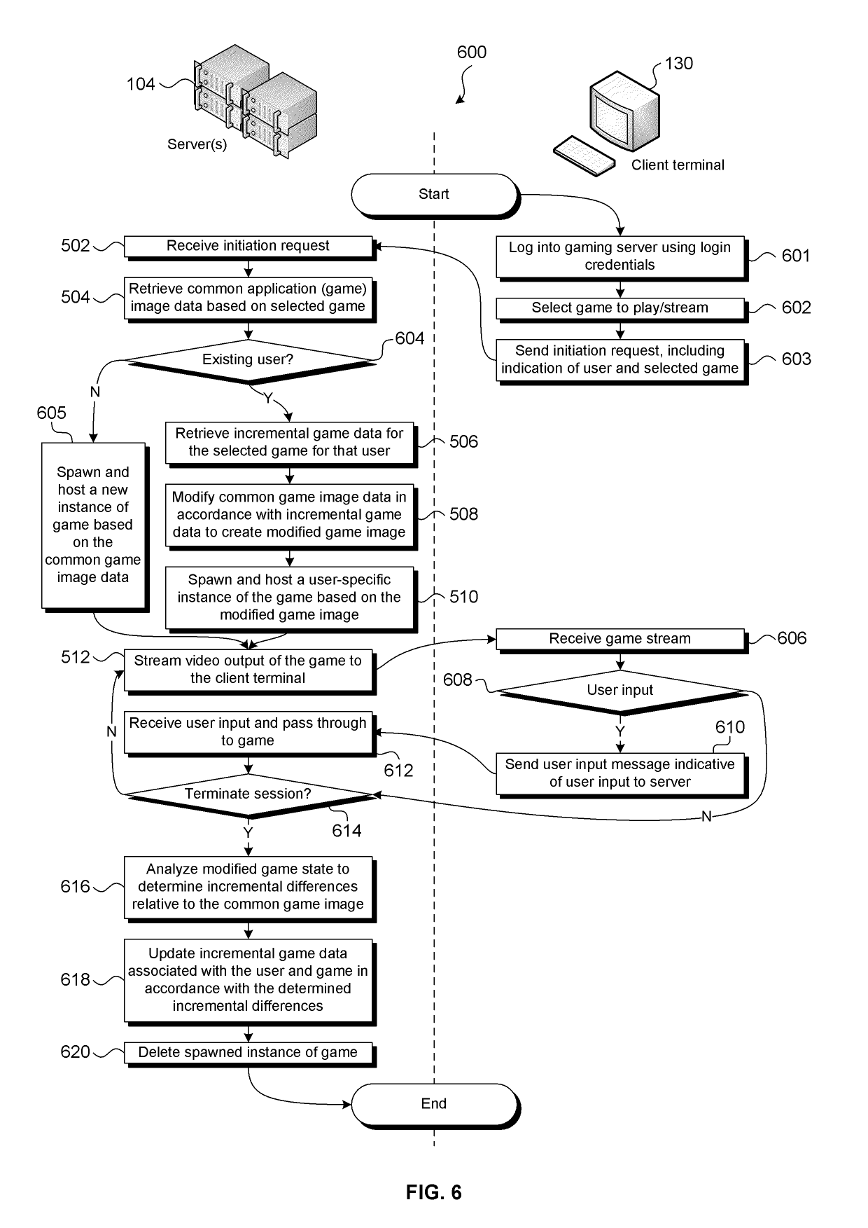

FIG. 5 shows a method 500 of server-based application hosting and streaming of video output of the application, in accordance with the disclosure. In summary, the method 500 comprises receiving (at block 502) an initiation request to stream a game 220. The initiation request is received via the Internet from the client terminal 130 and identifies the user 132 (e.g. user no. 1 132.1). The method 500 includes retrieving (at block 504) a common game data image from the game database 106 of the game which the user 132 wishes to play. If present, incremental game data is retrieved (at block 506) which is associated with the user 132 and indicative of a previous game state.

The common game data image is then modified (at block 508) in accordance with the incremental game data to create a modified game image which is then spawned and executed (at block 510) by the gaming server 104. Video and audio output of the game 220 is then streamed (at block 512) to the client terminal 130 for display as though the game was being processed locally by the client terminal 130.

### Practical Example

A gaming company wishes to host and provide online games for streaming and playing. These games may include games not intended to be hosted and streamed, e.g. Call of Duty, Starcraft II, etc. The servers 102, 104 are provided. Various gaming servers 104 are designated for particular games/regions, etc. The management server 102 manages and allocates gaming services 102 and also serves as an initial login and user management portal via which users 130 may interact.

First, a control index of the OS 202 is created. This control index could be used for every game 220, so only needs to be done once. This is done by the control index module 206 which traverses all of the files and folders of the file system and the registry of the OS 202. A hash value for each file is generated using an MD5 checksum, and the file, its size and checksum are stored, e.g. in the application database 106 or elsewhere. Alternatively, any one-way hash (SHA, LSH, Jenkins, Pearson, Zobrist, Tiger, RIPEMD, etc.) may be used.

Then, for each game 220, the common game data image is created. This may be done by installing the game 220 on the OS 202, and once again traversing, by the control index module 206, the file system and registry. Instead of storing all the files again, however, only the incremental changes or deltas are logged and stored, and these form the common game data image. Non-related folders (e.g. of anti-virus programs, temp files, etc.) can be excluded. The indexing of each game 220 needs to be done once per game only, and is re-used for each gaming session. The common game data image is stored on the game database 106 local to each gaming server 106 which is intended to support that game 220.

When a user 132 wishes to play one of the offered games 220, he accesses the management server 102. The gamer 132 need not be aware of the management/gaming server dichotomy, but merely needs to have his web browser or other app pointed towards the management server 102. If it is the first time that the gamer 132 accesses the server 102, he will need to undergo a signup process, during which time he is issued with login credentials. Also, he may need to download software for the client agent 302 to be installed on his client terminal 130. The client agent 302 is offered for download by the management server 102.

Once signed up, the gamer 132 logs in (at block 601) using his login credentials which serve to identify him uniquely to the system 100. A general profile can be created for him, e.g. preferences, region, language, connection speed, etc. The first time he logs in, he would not yet have played any games 220 and will not have any incremental game data, or saved game information, stored in his profile. He is presented with a GUI showing available games for hosting and streaming. He selects (at block 602) one of the games to play, using the input devices coupled to his client terminal 130 which (under the direction of the client agent 302) sends (at block 603) an initiation request to the management server 102 identifying the selected game.

The management server 102 allocates a gaming server 104 to the gamer 132 based on the selected game and other criteria, e.g. a North American gaming server 104 is allocated to a gamer in the North America region. The gaming server 104 creates a new gaming session, for example by using the “clean” control index. The gaming server 104 interrogates the gaming database 106 and retrieves (at block 504) the common game data image associated with the selected game. Before executing the game 220, the application module 208 determines (at block 604) whether the gamer 132 is new (and therefore has no incremental/saved game data) or is existing (and therefore has incremental/saved game data). If the gamer is new, the application module 208 launches or spawns (at block 605) the game 220 based only on the common game data image, e.g. a new game. The gamer 132 may then proceed as though he had just installed the game on his local terminal and was playing it for the first time.

Alternatively, if the gamer 132 is a returning player, he may like to resume the game 220 from the previous game state, e.g. load a saved game. Thus, and mentioned in method 500, the application module 208 proceeds to interrogate and retrieve (at block 506) the incremental game data associated with the specific gamer 132 and the specific game 220 from the profile database 108. The application module 208 then modifies (at block 508) the common game data image with the incremental game data before spawning and hosting (at block 510) a gamer-specific instance of the game 220. More specifically, the game 220 is restored to the last game state when the gamer 132 played and left previously. Any new files needed to be modified or created in the OS 202 are contained in the incremental game data and are written to the OS 202.

The gaming server 104 runs the game 220 and, using the streaming module 214, streams (at block 512) a video and audio output stream to the client terminal 130 for display thereon. Accordingly, the client terminal 130 receives (at block 606) the stream and displays/outputs it locally for viewing by the gamer 132. Typically, games involve interaction and it may be required to issue commands, e.g. move left, shoot, build a new structure, etc. The gamer 132 may input (at block 608) a user command via the input peripherals of the client terminal 130 which then sends (at block 610) user input messages to the gaming server 104. The input module 212 receives (at block 612) and interprets these input messages and parses the input back to the game 220 as though it emanated from an input device directly coupled to the gaming server 104.

At some point, the gaming session may be terminated (at block 614). This may arise due to user termination, disconnection, etc. When the session is terminated, the incremental game data needs to be updated to reflect the game state just prior to disconnection. The profile module 210 analyzes (at block 616) the latest modified game state to determine the incremental differences between it and the common game state. These incremental changes can include new or updated folders and files and/or registry entries. Only changed files/entries are recorded. The determined incremental changes are then updated (at block 618) to the incremental game data associated with the particular gamer 132 and game 220 and stored in the profile database 108. Thereafter, the game 202 can be deleted (at block 620) to free up storage space and resources on the gaming server 104. This may involve reverting the OS 202 to the control index. The gaming server 104 is then available for re-allocation.

Other events, e.g. gamer-initiated saves or auto-saves, could also trigger an incremental data analysis and update (at blocks 616, 618).

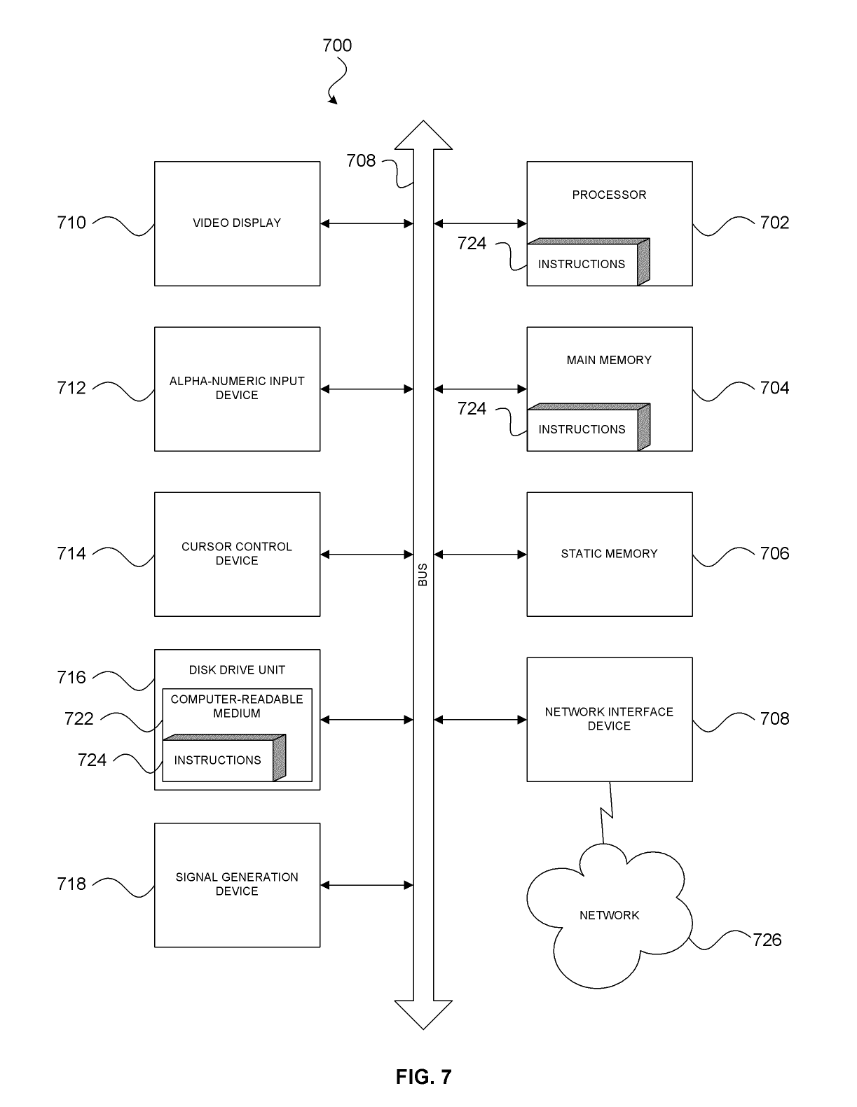

FIG. 7 shows a diagrammatic representation of a computer 700 within which a set of instructions, for causing the computer 700 to perform any one or more of the methodologies computer 700 herein, may be executed. In a networked deployment, the computer 700 may operate in the capacity of a server or a client machine in server-client network environment, or as a peer machine in a peer-to-peer (or distributed) network environment. The computer 700 may be a personal computer (PC), a tablet PC, a set-top box (STB), a Personal Digital Assistant (PDA), a cellular telephone, a web appliance, a network router, switch or bridge, or any computer 700 capable of executing a set of instructions (sequential or otherwise) that specify actions to be taken by that computer 700. Further, while only a single computer 700 is illustrated, the term “computer” shall also be taken to include any collection of computers that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both, a main memory 704 and a static memory 706, which communicate with each other via a bus 708. The computer 700 may further include a video display unit 710 (e.g., a liquid crystal display (LCD)). The computer 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a computer-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, the main memory 704 and the processor 702 also constituting computer-readable media.

The software 724 may further be transmitted or received over a network 726 via the network interface device 720 utilizing any one of a number of well-known transfer protocols (e.g., HTTP, FTP).

While the computer-readable medium 722 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer 700 and that cause the computer 700 to perform any one or more of the methodologies of the present embodiments, or that is capable of storing, encoding or carrying data structures utilized by or associated with such a set of instructions. The term “computer-readable medium” shall accordingly be taken to include, but not be limited to, solid-state memories and optical and magnetic media.

The gaming server 104 and/or management server 102 may include at least some of the components of the computer 700.

The Applicant believes that the disclosure provides a storage- and bandwidth-efficient way of server-based gaming and of storing modified game states. Retrieving a game state is fast because only incremental data needs to be retrieved from central storage, not common game data. This may save GB of storage space and bandwidth. Analysis of modified game states is also fast because the file system is already indexed. Thus, only incremental changes are saved and there is no need to traverse the file system or registry every time.

What is claimed is:

1. A method of server-based application hosting and streaming of video output of the application across a telecommunications network to a client terminal, the method including:
receiving, via the telecommunications network, an initiation request from a client terminal to stream an application from an application server to the client terminal, the request including at least an indication of a user;
retrieving from an application database a common application data image of the application;
retrieving from a profile database incremental application data uniquely associated with the user, the incremental application data being indicative of a recent application state for the user;
modifying the common application data image in accordance with the incremental application data, thereby to create a modified application image which is unique to the user and indicative of the recent application state;
spawning and hosting a user-specific instance of the application based on the modified application image; and
streaming, via the telecommunications network, at least video output of the user-specific instance of the application to the client terminal.

2. The method as claimed in claim 1, in which the common application data image is applicable to every potential user of the application, while each user has incremental application data uniquely associated with him/her.

3. The method as claimed in claim 1, in which, as the user-specific instance of the application is hosted and executed, the application state is further modified.

4. The method as claimed in claim 1, which includes:
receiving, via the telecommunications network, a user input from the client terminal; and
passing the user input to the application.

5. The method as claimed in claim 4, which includes modifying the application state in accordance with the user input.

6. The method as claimed in claim 1, which includes:
analyzing the modified application state to determine incremental differences relative to the common application data image; and
updating, in the profile database, the incremental application data associated with the user in accordance with the determined incremental differences.

7. The method as claimed in claim 1, which includes deleting the user-specific instance of the application after use.

8. The method as claimed in claim 1, in which:
the application is run on a Microsoft™ Windows™ platform; and
analyzing the modified application state includes:
analyzing the file system; or
analyzing the system registry.

9. The method as claimed in claim 8, which includes the prior step of analyzing the file system and/or system registry prior to installation of a particular application, thereby to create a control index of a “clean” system, in other words a control index of the system without any application-specific files.

10. The method as claimed in claim 9, in which analyzing the file system and/or system registry includes traversing all folders and files of the system.

11. The method as claimed in claim 10, in which analyzing the system further includes generating a checksum for each file/folder and in which the control index includes a copy of each file/registry entry, its size and checksum.

12. The method as claimed in claim 8, which includes installing the application on the system and thereafter analyzing the system again, thereby to create a common application data image.

13. The method as claimed in claim 12, in which the common application data image is created by comparing changes in the system after installation of the application to the system prior to installation of the application, namely the control index.

14. The method as claimed in claim 13, in which the common application data image is be stored in the application database.

15. The method as claimed in claim 14, in which the application database is connected directly to an application server, while the profile database is distributed or remote from the application server.

16. A system for server-based application hosting and streaming of video output of the application across a telecommunications network to a client terminal, the system including:
a network interface operable to receive an initiation request from a client terminal to stream an application from an application server to the client terminal, the request including at least an indication of a user;
an application module operable to:
retrieve from an application database a common application data image of the application;
retrieve from a profile database incremental application data uniquely associated with the user, the incremental application data being indicative of a recent application state for the user;
modify the common application data image in accordance with the incremental application data, thereby to create a modified application image which is unique to the user and indicative of the recent application state; and
spawn and host a user-specific instance of the application based on the modified application image; and
a streaming module operable to stream, via the network interface and the telecommunications network, at least video output of the user-specific instance of the application to the client terminal.

17. The system as claimed in claim 16, which includes an input module to:
receive a user input from the client terminal; and
pass the user input to the application.

18. The system as claimed in claim 16, which includes a profile module operable to:
analyze the modified application state to determine incremental differences relative to the common application data image; and
update, in the profile database, the incremental application data associated with the user in accordance with the determined incremental differences.

19. The system as claimed in claim 16, which includes a control index module operable to:
analyze a file system/system registry prior to installation of the application thereby to create a control index;
analyze the file system/system registry after installation of the application thereby to create a common application data image.

20. A non-transitory computer-readable medium having stored thereon a computer program which, when executed by a computer, causes the computer to perform a method as claimed in claim 1.
